(19) United States
(12) Patent Application Publication
(10) Pub. No.: US 2013/0265397 A1
(43) Pub. Date: Oct. 10, 2013

(54) IMAGE PROCESSING APPARATUS AND IMAGE PROCESSING METHOD

(71) Applicant: SEIKO EPSON CORPORATION, Tokyo (JP)

(72) Inventor: Kan MATSUDA, Shiojiri (JP)

(73) Assignee: SEIKO EPSON CORPORATION, Tokyo (JP)

(21) Appl. No.: 13/853,517

(22) Filed: Mar. 29, 2013

(30) Foreign Application Priority Data
Apr. 4, 2012 (JP) 2012-085694

(51) Int. Cl. H04N 13/04

(52) U.S. Cl. CPC H04N 13/0404
USPC 348/51

(57) ABSTRACT

To provide a plan in which it is possible to prevent wasteful consumption of the lenticular lens, an image processing apparatus that forms a 3-D viewable image via a lenticular lens, wherein it has a suitability determination means that determines the suitability of the combination of the first feed image and the second feed image for the image for 3-D viewing based on the position relationship between the corresponding points of the first feed image and the second feed image having a parallax with respect to each other, and a means that notifies the user about the determination result obtained by the suitability determination means; here, the suitability determination means works as follows: when the first feed image and the second feed image overlap each other so that a pair of corresponding points are in agreement with each other.

### CROSS-REFERENCE TO RELATED APPLICATIONS

This application claims priority to Japanese Patent Application No. 2012-085694 filed on Apr. 4, 2012. The entire disclosure of Japanese Patent Application No. 2012-085694 is hereby incorporated herein by reference.

### BACKGROUND

1. Technical Field

The present invention relates to an image processing apparatus and an image processing method that form a 3-D viewable image via a lenticular lens.

2. Background Technology

As a scheme for the 3-D display of images, the method that exploits the parallax vision of two eyes has been adopted in practical applications. For example, there is the following technology: from plural images taken from the views different from each other, rectangular images are cut out and a parallax-attached image for 3-D viewing is formed as these rectangular images are arranged side by side sequentially corresponding to the configuration of the views. As the image for 3-D viewing is presented via a lenticular lens, there is a parallax between the images that reach the left eye and the right eye, respectively, so that the objects in the image can be viewed in 3-D. For example, Patent Document 1 discloses an image processing apparatus that can automatically form the image for 3-D viewing appropriate for 3-D viewing by using a lenticular lens.

Japanese Laid-open Patent Publication No. 2004-104329 (Patent Document 1) is an example of the related art.

### SUMMARY

### Problems to Be Solved by the Invention

For the lenticular lens, the depth range that allows the 3-D display of the image is predetermined corresponding to its material, the dimensions of the convex lenses, etc. If this range is overrun, the 3-D displayed object becomes not vivid. It is preferred that the user know beforehand whether the 3-D image obtained via the lenticular lens is included in the aforementioned range. However, there is no such scheme in the prior art. Consequently, in the prior art up to now, only after the image for 3-D viewing is printed on a lenticular sheet with the lenticular lens or after the medium having the image for 3-D viewing printed on it is bonded on the lenticular sheet, and the user can view the image via the image for 3-D viewing, can the user find out whether the 3-D image is good/poor. As a result, the lenticular sheet is wasted.

Some embodiments of the present invention solve the problem by providing a plan in which where it is possible to prevent the waste of the lenticular sheet.

### Means used to Solve the Above-Mentioned Problems

An embodiment of the present invention provides an image processing apparatus that forms a 3-D viewable image via a lenticular lens. The image processing apparatus has a suitability determination means that determines the suitability of the combination of the first feed image and the second feed image for the image for 3-D viewing based on the position relationship between the corresponding points of the first feed image and the second feed image, having a parallax with respect to each other, and a means that notifies the user about the determination result obtained by the suitability determination means. Here, the suitability determination means works as follows: when the first feed image and the second feed image overlap each other so that a pair of corresponding points are in agreement with each other, if the spacial distance between another pair of corresponding points is larger than a threshold preset corresponding to the lenticular lens, it is determined that the combination of the first feed image and the second feed image is not suitable.

Another embodiment of the present invention relates to an image processing method for forming the image for 3-D viewing that can be viewed as 3-D via a lenticular lens. According to this image processing method, there are the following steps of operation: a suitability determination step in which the suitability of the combination of the first feed image and the second feed image for the image for 3-D viewing is determined based on the position relationship between the corresponding points of the first feed image and the second feed image having a parallax with respect to each other, and a notification step in which the user is notified about the determination result obtained by the suitability determination means. Here, in the suitability determination step, when the first feed image and the second feed image overlap each other, so that a pair of corresponding points are in agreement with each other, if the spacial distance between another pair of the corresponding points is larger than a threshold preset corresponding to the lenticular lens, it is determined that the combination of the first feed image and the second feed image is not suitable.

According to the present invention with this configuration (the image processing method and the image processing apparatus), when the first feed image and the second feed image overlap each other so that a pair of corresponding points are in agreement with each other, if the spacial distance between another pair of corresponding points is larger than a threshold preset corresponding to the lenticular lens, it is determined that the combination of the first feed image and the second feed image is not suitable. As a result, by setting a threshold corresponding to the magnitude of the parallax where it is possible to make a suitable 3-D display with the lenticular lens, it is possible to determine whether the parallax generated due to a combination of the feed images is within the range wherein suitable display can be made by the lenticular lens. This determination result is not notified to the user, so that the user can find out beforehand whether the image for 3-D viewing, made of a combination of the first feed image and the second feed image, is suitable. As a result, when it is determined that the image for 3-D viewing consulting of a combination of the first feed image and the second feed image is not suitable, the user can stop the printing of the image for 3-D viewing on the lenticular sheet, or can stop the bonding of the medium with the image for 3-D viewing printed on it on the lenticular sheet. As a result, it is possible to prevent the waste of the lenticular sheets.

When the overlap degree of the object in the first feed image and the second feed image is higher, the similarity of the images in the overlapped regions of the first feed image and the second feed image is larger. Consequently, the integrated value obtained by integrating the absolute value of the difference in the pixel value of the corresponding pixels (pixels in agreement with each other) in the overlapped region is smaller. In particular, when the overlap degree of a certain object is the maximum, the integrated value is at the minimum value. In other words, at the shift quantity where the integrated value is the minimum value, the overlap degree of a certain object becomes the maximum. In this overlapped state, there are corresponding points where the two feed images are in agreement with each other in the image regions corresponding to the object. That is, at the shift quantity where the integrated value is the minimum value, there is a certain object including the corresponding points in agreement with each other in the two feed images, and, at another shift quantity where the integrated value also is the minimum value, there is another object including the corresponding points where the two feed images are in agreement with each other. Consequently, when the feed images are overlapped so that a pair of the corresponding points is in agreement with each other, the spacial distance between another pair of the corresponding points can be determined as the difference in the shift quantity where each minimum value is displayed when the integrated value displays plural minimum values.

Here, according to the present invention, the suitability determination means works as follows: the absolute value of the difference in the pixel values of the corresponding pixels in the overlapped region of the first feed image and the second feed image when the second feed image is shifted with respect to the first feed image is integrated; the integrated value is determined for each shift quantity, and the difference in the shift quantity for which the integrated value is the minimum value is taken as the spacial distance. When the spacial distance is determined based on the integrated value of the difference in the pixel value as, the integrated value can only be determined by an addition/subtraction operation, so that the arithmetic and logic operation load can be reduced. A processor without a high processability can handle the operation well. Consequently, carrying out this technology does not boost the cost of the apparatus, and the functions can be realized even in low-price products. In addition, it is possible to quickly present the suitability determination result to the user.

Here, it is believed that because the minimum value of the integrated value is smaller. the similarity of the images in the overlapped region of the first feed image and the second feed image is larger at the shift quantity. That is, it is believed that for the shift quantity, the overlap degree of the object with a large area becomes the maximum. Such an object is believed to have a more significant presence feeling in the image, so that an appropriate 3-D display is desired for it. When the 3-suitable D display of the object with a large area in 3-D is taken as the priority, the suitability determination means determines the suitability based on the spacial distance determined as the difference between the shift quantity for which the integrated value has the smallest minimum value and the shift quantity for which the integrated value has the second smallest minimum value.

Also, when the feed image includes plural objects, there is a demand to make a suitable 3-D display for as many objects as possible. In such a case, the suitability determination means may determine the suitability based on the maximum spacial distance among the plural spacial distances determined from the shift quantities at the various minimum values. With this determination method, a determination is made on whether the two objects with the largest difference between their depth positions when the 3-D display is carried out can be 3-D displayed vividly. Consequently, when the result of the suitability determination indicates that the combination of the first feed image and the second feed image is suitable, the other objects located between these two objects in the depth direction can also be 3-D displayed vividly, so that many objects can be 3-D displayed vividly.

It is preferred that the notification means also visually displayed the second feed image, whose suitability for its combination with the first feed image has been determined by the suitability determination means, together with the determination result. With such a configuration, the user can easily find out, from among a few images, the suitable combination of the feed images for forming the image for 3-D viewing. Among the second feed images visually displayed there, by simply selecting one or several images determined to be suitable for the combination with the first feed image, the user can easily select the feed images suitable for forming the image for 3-D viewing.

In addition, the image processing apparatus related to the present invention may also have a means for printing and for the output of the image for 3-D viewing. By combining the printed image for 3-D viewing with a lenticular lens, it is easy to provide a 3-D image that can suitably make the 3-D display.

### BRIEF DESCRIPTION OF THE DRAWINGS

Referring now to the attached drawings which form a part of this original disclosure:

FIG. 1 is a diagram illustrating the printing system adopting an embodiment of the image processing apparatus related to the present invention;

FIG. 2 is a flow chart illustrating the 3-D image printing mode in this embodiment;

FIG. 3 is a diagram illustrating an example of the feed images;

FIGS. 4A-4C are diagrams illustrating the concept of shift of the feed images;

FIG. 5 is a diagram illustrating the concept of smoothing;

FIG. 6 is a diagram illustrating the method for detecting the minimum point;

FIG. 7 is a diagram illustrating the spacial distance in this embodiment; and

FIG. 8 is a diagram illustrating an example of display in the display unit.

### DETAILED DESCRIPTION OF EXEMPLARY EMBODIMENTS

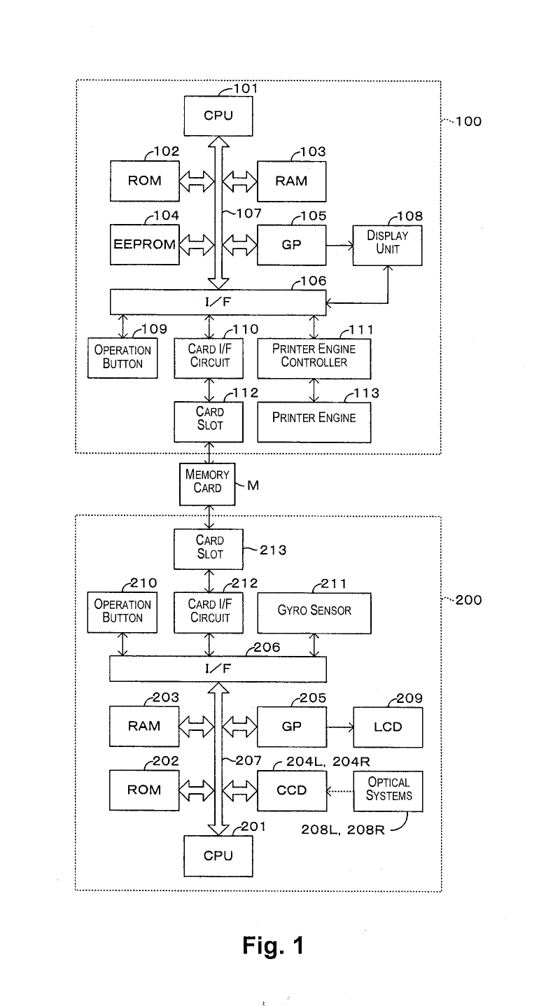

FIG. 1 is a diagram illustrating the printing system adopting an embodiment of the image processing apparatus of the present invention. According to this printing system, the image data acquired by picture taking with a digital camera 200 are sent by a memory card M, a USB (universal serial bus) cable, a wireless LAN (Local Area Network), or the like to a printing apparatus 100, and are printed out by the printing apparatus 100. That is, here, the user uses the digital camera 200 to take pictures to generate the image data, and the image data are read and printed as is on the printing apparatus 100 in the so-called direct printing mode. However, the present invention is not limited to this printing system. That is, the present invention may also be adopted in a printing system where the image data generated by the digital camera 200 are fetched into a personal computer or a cell phone or the like, with the image data then being sent from the personal computer to the printing apparatus 100 for printing. However, the present invention is not limited to a system having both the digital camera 200 and the printing apparatus 100. The invention may also be adopted in any image processing apparatus for the image data in a general sense.

As shown in the figure, the digital camera 200 has a CPU (central processing unit) 201, a ROM (read-only memory) 202, a RAM (random access memory) 203, CCDs (Charge Coupling Devices) 204L, 204R, a graphic processor (GP) 205 and an interface (I/F) 206 connected with each other via a bus 207. Information can be exchanged among them. Corresponding to the program stored in the ROM 202, the CPU 201 executes various types of arithmetic and logic operation processes, while the CPU controls the digital camera 200. In this case, the data that are temporarily needed are stored in the RAM 203.

Also, the CCDs 204L, 204R convert the optical images from the object with light collected by the optical systems 208L, 208R into electric signals for output. More specifically, the optical image collected by the optical system 208L is incident on the CCD 204L, while the optical image collected by the optical system 208R is incident on the CCD 204R. The optical systems 208L, 208R are arranged separated from each other on the left/right portions of the case of the digital camera 200, respectively. More specifically, the optical system 208L is arranged on the left side with respect to the object on the front surface of the case of the digital camera 200, while the optical system 208R is arranged on the right side with respect to the object. Consequently, there is a parallax between the images taken by the CCDs 204L, 204R, respectively.

The optical system 208L each are made of plural lenses and actuators. The actuators work to adjust the focus or the like while the optical images of the object are formed by the plural lenses on the light receiving surfaces of the CCDs 204L, 204R, respectively.

The digital camera 200 can selectively execute the following modes: a 3-D image pickup mode, in which the two CCDs 204L, 204R are used to take a pair of pictures with a parallax between them, and the well-known image pickup mode in which anyone of the CCDs is used to carry out image pickup. The one pair of image data taken in the 3-D image pickup mode is stored as a correlated pair. In the process for forming the 3-D viewable synthetic image to be explained later, the image taken by the CCD 204L is used as the feed image for the left eye and the image taken by the CCD 204R is used as the feed image for the right eye.

In addition, the GP 205 executes the image processing for display based on the display command sent from the CPU 201, and the obtained image data for display are sent to the liquid crystal display (LCD) 209 for display.

The I/F 206 provides the input/output function of the digital camera 200. When the information is exchanged between the operation button 210, the gyro sensor 211, and the I/F circuit 212, the I/F makes appropriate conversion for the format of the data for display. The operation button 210 connected to the I/F 206 has the buttons for power supply, mode switching, shutter, etc., and the input means that can set the various types of functions. As a result, the user can control the digital camera 200 at will for the desired operation. Here, the gyro sensor 211 generates and outputs a signal indicating the angle (the angle with respect to the horizontal plane) of the camera main body when the image of the object is taken by the digital camera 200. The digital camera 200 generates the various types of information (such as exposure, information about the object, etc.) in the image pickup operation including the angle of the camera main body.

According to the present embodiment, the digital camera 200 has a structure that allows a description of the image pickup information as the Exif (Exchangeable Image File Format) information, and generation of the image file attached on the image data. The structure of the Exif image file is basically the well-known JPEG (Joint Photographic Expert Group) image format. In this image file, the thumbnail image, the image pickup related data, and other data are buried in the format according to the JPEG code. In addition, it has the function of forming and recording the image file (MPO file) based on the MP (Multi Picture) that has plural still picture image data recorded in one image file.

The I/F circuit 212 is an interface for reading the information with the memory card M inserted in the card slot 213. In addition, the I/F 206 also has the function of connecting with the USB, wireless LAN, and other external equipment not shown in the drawing; the I/F allows exchange of the image file with the printing apparatus 100 either with wires or wirelessly.

The printing apparatus 100 is an apparatus that prints out the images taken by the digital camera 200. The printing apparatus has the following configuration. In the printing apparatus 100, the CPU 101, the ROM 102, the RAM 103, the EEPROM (electrically-erasable-programmable ROM) 104, the GP 105, and the I/F 106 are connected with each other via the bus 107. Information can be exchanged between them. The CPU 101 executes the various types of arithmetic and logic operation process corresponding to the programs stored in the ROM 102 and the EEPROM 104; at the same time, the CPU controls the various sections of the printing apparatus 100. In addition, the CPU 101 has the program and data as the subject for execution temporarily stored in the RAM 103; also, the CPU has the data to be maintained even after turning off the power supply of the printing apparatus stored in the EEPROM 104. Besides, as needed, the CPU 101 sends the display command to the GP 105, the GP 105 executes the image processing for display corresponding to the display command, and the result of the process is sent to the display unit 108 for display.

The I/F 106 is an apparatus that makes appropriate conversion for the data display format when information exchange is carried out between the operation button 109, the card I/F circuit 110, and the printer engine controller 111. In the printing apparatus 100, the operation button 109 has a configuration for pressing to make menu selection, etc., of the printing apparatus 100. Also, the card I/F circuit 110 is connected to the card slot 112, and the image file generated by the digital camera 200 is read from the memory card M inserted into the card slot 112. Also, the I/F 106 has the function of connection with the USB, the wireless LAN, and other external equipment not shown in the drawing, and the image file is exchanged with the digital camera 200 either by wires or wirelessly.

The display unit 108 has a touch panel arranged on the surface of the display unit made of, e.g., LCD. In addition to displaying the image data sent from the GP 105 on the display unit, the operation input data input by the user on the touch panel are output to the I/F 106.

For the printing apparatus 100, as the image data are received via the memory card M or by data communication, various processes are carried out by the CPU 101; at the same time, the printer engine controller 111 controls the printer engine 113, then the image corresponding to the image data is printed. In the following, the 3-D image printing mode will be explained. According to this mode, an image for 3-D viewing is formed from the image data corresponding to one pair of left/right feed images taken by the digital camera 200 in the 3-D image pickup mode and, in combination with a lenticular lens, the image is printed on a recording sheet.

In addition, it is possible to execute the various printing operations that can be carried out by the printers of this type. However, these printing operations are well known technologies, and they can be adopted in the present embodiment too, so they will not be explained in this specification. In addition, the principle of the 3-D viewing by the lenticular image and the method of the principle for forming an image from plural feed images are also well known. Consequently, they will not be explained in detail here.

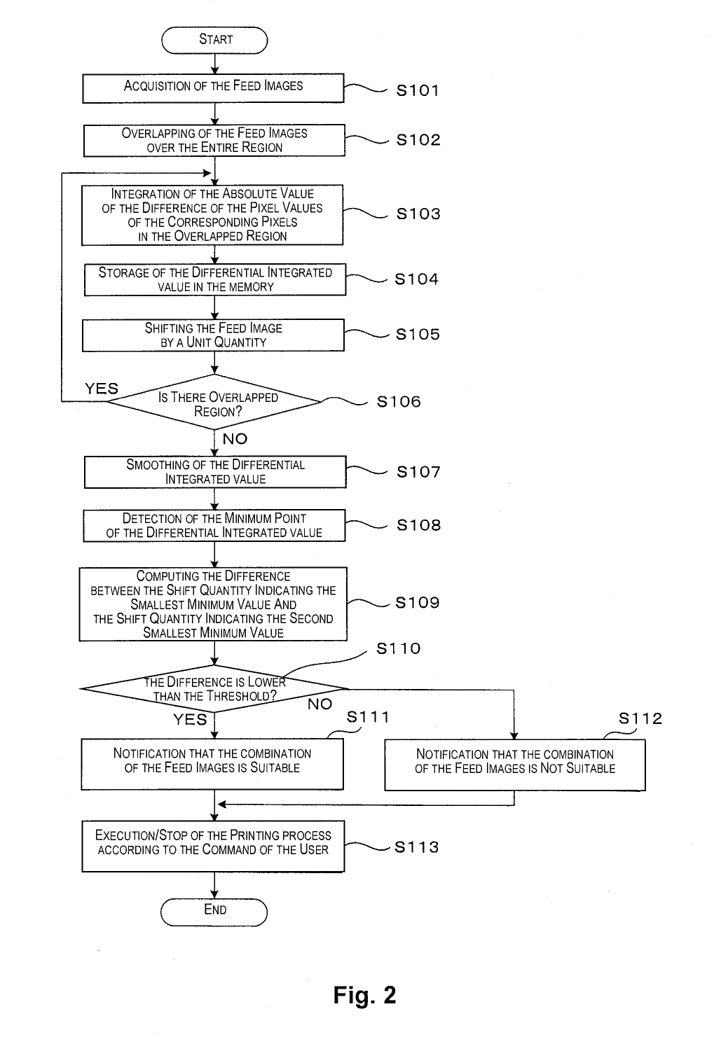

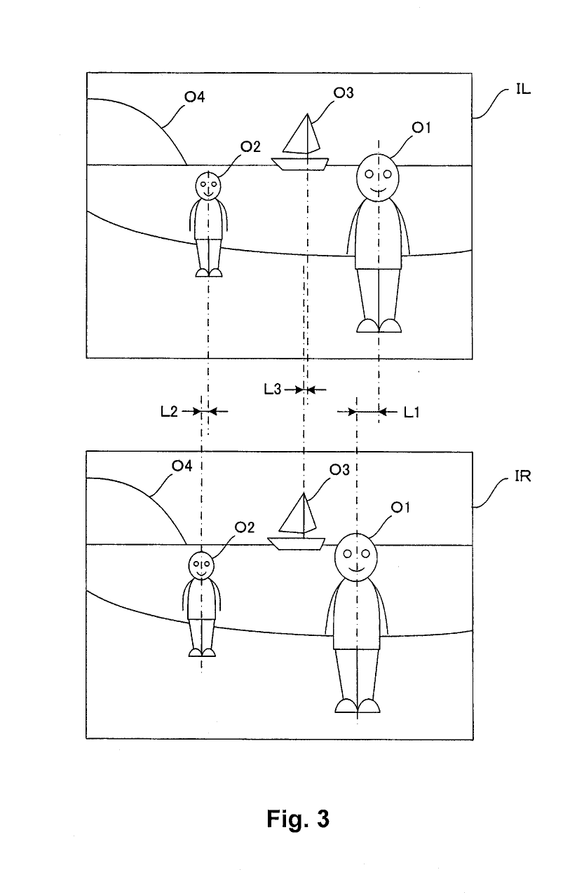

FIG. 2 is a flow chart illustrating the 3-D image printing mode in this embodiment. FIG. 3 is a diagram illustrating an example of the feed images. In this printing mode, first of all, the feed images as the origin of the 3-D image are acquired (step S101). The feed images should be plural images having parallax with respect to each other. For example, it is possible to use one pair of images taken by the digital camera 200 in the 3-D image pickup mode. However, the feed images are not limited to this type. For example, for a group of plural images taken for the same object from different views, such as a group of the images formed using, for example, computer graphics technology, a technology to be described below, may also be adopted. The number of images that include one group of feed images may be 2 or larger.

Here, an explanation will be made on the case in which two images are taken by the digital camera 200 in the 3-D image pickup mode. In the 3-D image pickup mode, as shown in FIG. 3, two images IL, IR are taken for the same object from different views. Here, the image IL is one taken by the CCD 204L arranged on the left side in the digital camera 200, and the image is used as the feed image for the left eye when an image for 3-D viewing is formed. On the other hand, the image IR is the image taken by the CCD 204R arranged on the right side in the CCD 204L, and the image is used as the feed image for the right eye when an image for 3-D viewing is formed.

The main objects shared in these images include right-side person O1, left-side person O2, central yacht O3, and upper-left hill O4. Between the feed image IL for the left eye and the feed image IR for the right eye, there is a delicate difference in the positions of the objects corresponding to the distance between the camera and the objects in the image pickup operation. That is, for a farther object, there is little difference in the position between the left/right feed images IL, IR. Thus, the nearer the object to the camera, the larger the difference in the position of the object corresponding to the subject for picture taking.

In the example shown in FIG. 3, the right-side person O1 is on the front, and its difference L1 in position between the left/right feed images IL and IR is the largest. This difference then decreases in the order of the difference L2 for the position of the left-side person O2 on the back side, then the difference L3 of the position of the yacht O3 further on the back side. On the other hand, for the hill O4 far away, there is little difference in the position. In addition, for the actual images, the difference in the position caused by tilting of the camera, etc., may be added. When plural feed images are taken by individual cameras, and when picture taking is carried out by a single-lens camera via a 3-D adopter, the differences caused by such position shifts may also be added. In this embodiment, the feed images free of offset and tilt in the longitudinal direction or the feed images adjusted to eliminate the offset and tilt in the longitudinal direction are prepared. For the feed images IL, IR, only the difference in position in the left/right direction (parallax direction) takes place. Also, the feed images IL, IR have the same size.

When the feed images acquired are directly used as is to form the image for 3-D viewing, just as in the image pickup state, the farthest object (the hill) has zero parallax, while as the object moves to the front, the parallax increases, and the front object has the largest parallax and appears to pop out towards the viewer. On the other hand, considering the vividness of the objects, there is a tendency that the far-away object free of parallax will appear to be the most vivid, while as the object moves to the front, the image becomes blurred. For this type of 3-D image, while the object free of parallax is positioned on the same plane as the image plane and appears vivid, the object with parallax is positioned ahead (or behind) the image plane to display a depth appearance. Because the range in the depth direction that can be displayed in 3-D is limited, depending on the parallax degree, it may be impossible to reproduce the depth in the image pickup mode, so that such an object is not vivid.

As to be explained below, according to the present embodiment, it is possible to determine the suitability of the 3-D display for the combination of the feed images for forming the image for 3-D viewing with a certain lenticular lens. The determination result is notified to the user according to this configuration. Consequently, the user can find out beforehand whether the image for 3-D viewing, made of a combination of feed images, is suitable. As a result, when it is determined that the image for 3-D viewing made of a combination of the feed images is not suitable, the user can stop printing of the image for 3-D viewing on the lenticular sheet, or stop bonding of the medium with the image for 3-D viewing printed on it on the lenticular sheet. As a result, it is possible to prevent the waste of the lenticular sheets.

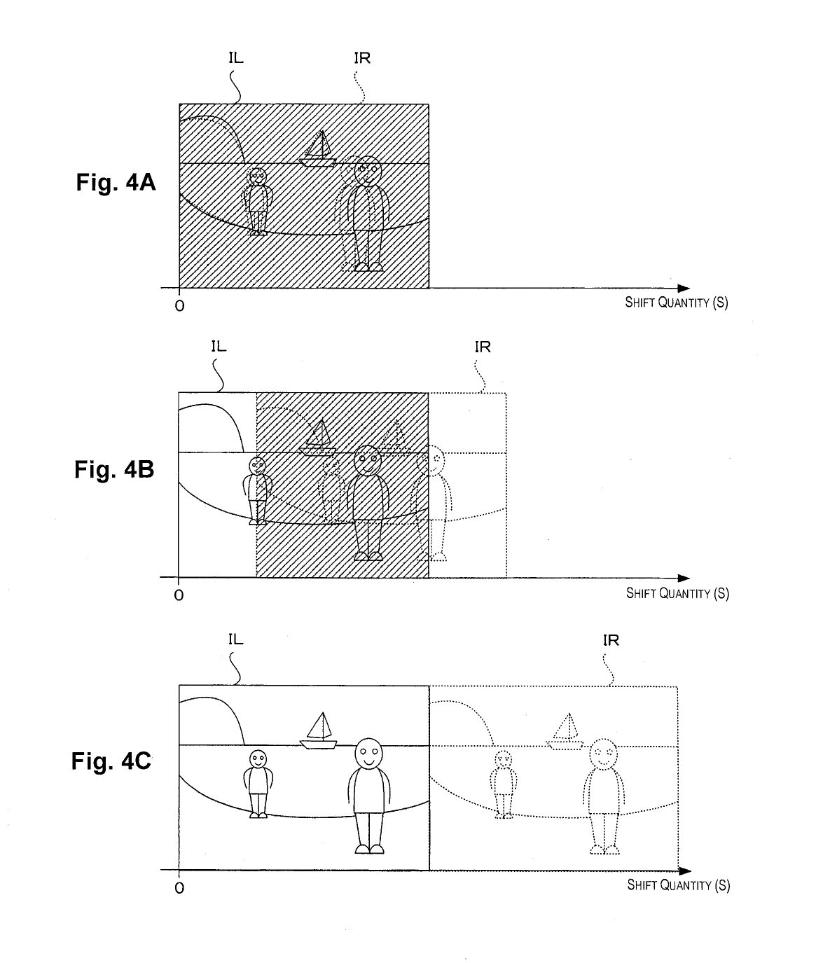

FIGS. 4A-4C are diagrams illustrating the concept of the shift of the feed images. As shown in FIGS. 4A-4C, the hatched portion refers to the region where the feed image IL for the left eye and the feed image IR for the right eye overlap each other (hereinafter to be referred to as “overlapped region”). According to the present embodiment, while the feed image IR for the right eye is shifted with respect to the feed image IL for the left eye, the overlapped region is gradually changed, and the process to be explained later is executed for the overlapped region as the subject. As a result, a determination is made on whether the combination of the feed images IL, IR is suitable as the image for 3-D viewing. Here, as shown in FIG. 4A, the process starts as the feed image IL for the left eye and the feed image IR for the right eye overlap each other for the entire region. The feed image IR for the right eye is gradually shifted to the right hand side in the drawing with respect to the feed image IL for the left eye (for example, the state shown in FIG. 4B) and, as shown in FIG. 4C, the feed image IR for the right eye is shifted until there is no overlapped region. In the following, the quantity of shift of the feed image IR for the right eye to the right side in the drawing is simply referred to as the “shift quantity”. Here, the quantity of shift of the feed image IR for the right eye in a single round is called 1 pixel width (hereinafter to be referred to as “unit quantity”). Also, when the feed image IL for the left eye and the feed image IR for the right eye are shifted with respect to each other, the shift start positions of the feed images IL, IR, the shift direction, and the shift quantity in each round may be changed appropriately.

Now, return to FIG. 2, and the further process in the 3-D image printing mode will be explained. As shown in FIG. 4A, the acquired feed images IL, IR overlap each other over the entire region (step S102). The difference in the pixel values of the corresponding pixels that have positions in agreement with each other (overlapped) in the overlapped state of the feed images IL, IR is then determined, and the absolute value of the difference is integrated for the entire overlapped region (step S103). The integrated value of the difference in the pixel values of the corresponding pixels (hereinafter to be referred to as “differential integrated value”) is stored in a memory, such as the RAM 103 (step S104). After the integrated value is stored in the memory, the feed images IL, IR are shifted with respect to each other by a unit quantity (step S105). According to the present embodiment, the feed image IR for the right eye is shifted by a unit quantity to the right hand side in FIGS. 4A-4C. Next, in the state after the shift, a determination is made on whether there is a region where the feed images IL, IR overlap each other (step S106). According to the present embodiment, it is possible to determine whether there is an overlapped region by determining whether the accumulated shift quantity of the feed image IR for the right eye is over the width of the feed images. Next, until it is determined that there is no overlapped region in step S106, the operation of steps S103 through S106 is carried out repeatedly, and the differential integrated value is determined for each shift quantity. The data of the differential integrated value are smoothened with respect to the shift quantity determined in this way (step S107), and the minimum point of the differential integrated value is detected from the smoothened data (step S108).

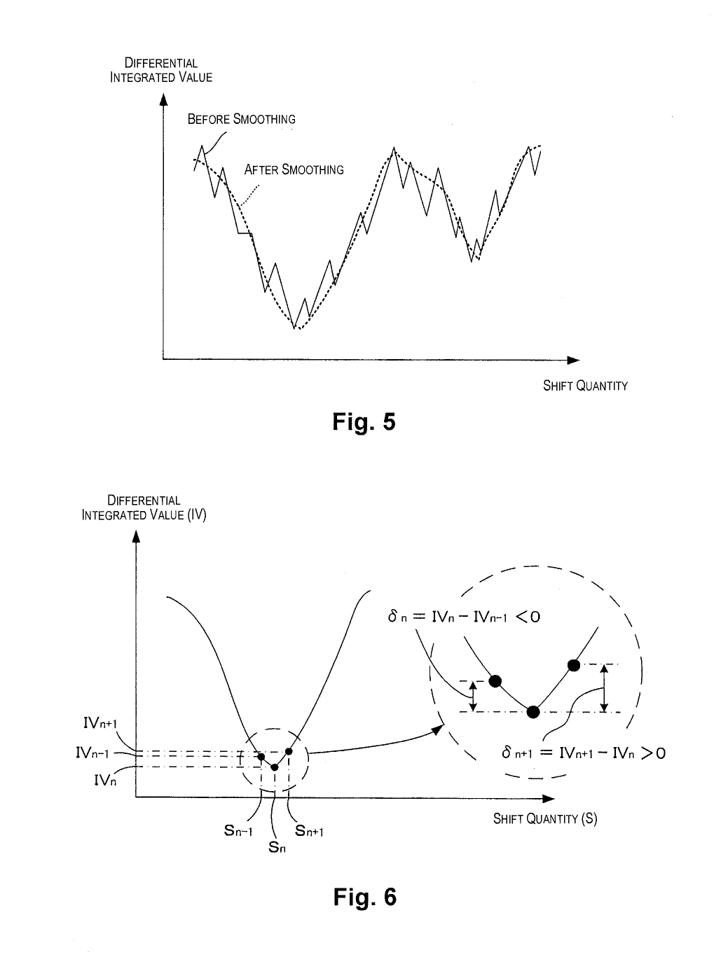

FIG. 5 is a diagram illustrating the concept of smoothing. FIG. 6 is a diagram illustrating the method for detecting the minimum point. According to this embodiment, the differential integrated value is computed in the overlapped region for each shift quantity. To be explained later, based on the shift quantity when the differential integrated value shows the minimum value, suitability is determined for the combination of the feed images IL, IR. In this case, the data are plotted with the abscissa representing the shift quantity and the ordinate representing the differential integrated value. As shown by the solid line shown in FIG. 5, there may be plural small crests/troughs (maximum values and minimum values) generated. When it is preferred that such small crests/troughs be ignored when a determination is made on the suitability of the combination of the feed images IL, IR, a suitable filtering process is carried out on the actual data of the differential integrated value with respect to the shift quantity so that the actual data are smoothened and, as indicated by the broken line shown in FIG. 5, the minimum point is detected based on the data after the smoothing process.

In the following, with reference to FIG. 6, an example of the method for determining the minimum value of the differential integrated value from the data after smoothing will be explained. Here, for the shift quantity of Sn, the differential integrated value is represented by IVn. For each shift quantity Sn, the following equations are adopted to sequentially compute the difference values δn, δn+1:

δₙ=IVₙ−IVₙ₋₁

δₙ₊₁=IVₙ₊₁−IVₙ

In a graph in which the abscissa represents the shift quantity and the ordinate represents the differential integrated value, when both the difference values δn, δn+1 are positive values, the graph rises to the upper-right side for the shift quantity Sn. When both the difference values δn, δn+1 are negative values, the graph descends to the lower-right side. At the minimum point where the graph changes from the lower-right side to the upper-right side, On has a negative value, while δn+1 has a positive value. Consequently, by detecting the point indicating the difference values δn, δn+1, it is possible to detect the minimum point of the differential integrated value. For the minimum point of the differential integrated value determined in this way, while the shift quantity Sn and the differential integrated value IVn are correlated to each other, they are stored in a memory, such as the RAM 103.

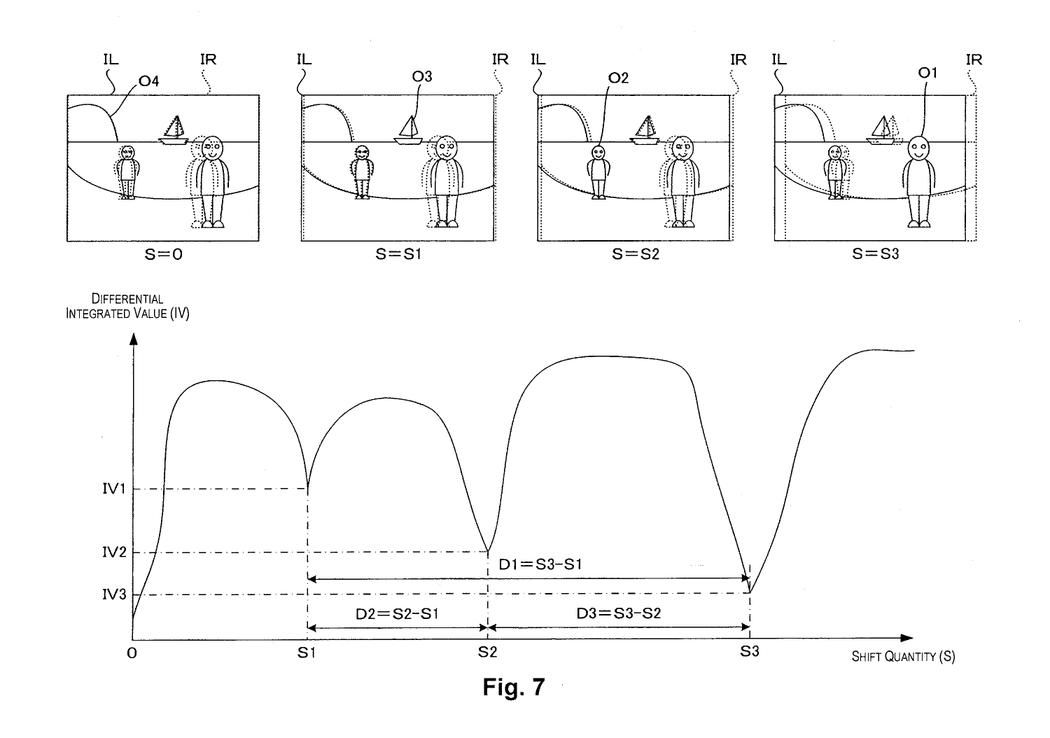

FIG. 7 is a diagram illustrating the spacial distance according to the present embodiment. The lower portion of FIG. 7 shows the graph after smoothing, where the abscissa represents the shift quantity S and the ordinate represents the differential integrated value IV. The upper portion of FIG. 7 shows the overlapped state of the feed images IL, IR at each shift quantity where the minimum value is displayed. Here, when the shift quantity is S1, S2 and S3, the differential integrated value shows the minimum values of IV1, IV2, and IV3, respectively. The shift quantity S1 is in agreement with the shift quantity when the overlap degree of the central yacht O3 becomes the maximum, the shift quantity S2 is in agreement with the shift quantity when the overlap degree of the left-side person O2 becomes the maximum, and the shift quantity S3 is in agreement with the shift quantity when the overlap degree of the right-side person O1 becomes the maximum.

For example, when the overlap degree of the right-side person O1 is high, in the image region corresponding to the right-side person O1, the difference in the pixel values of the corresponding pixels is nearly zero. Consequently, the differential integrated value for the overall overlapped region becomes significantly smaller near the shift quantity S3 where the overlap degree of the right-side person O1 becomes the maximum, and the minimum value is displayed for the shift quantity S3. This is not limited to the right-side person O1. It also applies on the other subject for image pickup.

In the following, with reference to FIG. 7, the “spacial distance” in the present invention will be explained. According to the present invention, when the feed images overlap each other so that a pair of corresponding points are in agreement with each other, the spacial distance refers to the distance between another pair of corresponding points. For example, when the feed images IL, IR overlap each other when the shift quantity is S1, the central yacht O3 has the highest overlap degree. Consequently, in the image region corresponding to the central yacht O3, there is a pair of corresponding points in the feed images IL, IR in agreement with each other. On the other hand, in this case, an offset takes place in the left/right direction for the persons O1, O2, so that offset takes place between the feed images IL, IR for the corresponding points in the image regions corresponding to the persons O1, O2. This offset quantity is the spacial distance. More specifically, when the feed images IL, IR are overlapped so that the corresponding points included in the image regions of the central yacht O3 are in agreement with each other, the spacial distance D1 between the corresponding points included in the image regions of the right-side person O1 is (S3-S1), and the spacial distance D2 of the corresponding points included in the image regions of the left-side person O2 is (S2-S1).

In the following, the meaning of spacial distance will be explained. When the image for 3-D viewing formed from the feed images, which have been subject to position adjustment and trimming to have the regions overlapped for the central yacht O3, is viewed via a lenticular lens, the central yacht O3 is positioned on the image plane and is vividly displayed. On the other hand, the persons O1, O2 are displayed in 3-D and appear to pop forward towards the viewer. In this case, the pop out quantities of the persons O1, O2 correspond to the offset quantities of the persons O1, O2 (corresponding to a large parallax) when the feed images IL, IR overlap each other to have the regions for the central yacht O3 overlap other. In other words, the pop quantities of the persons O1, O2 correspond respectively to the spacial distances D1, D2 of the corresponding points included in the image regions of the persons O1, O2 when the feed images IL, IR overlap each other, so that the corresponding points included in the image regions of the central yacht O3 are in agreement with each other. Consequently, when the left-side person O2 is displayed in the 3-D vividly on the image plane, whether the persons O1, O2 can be included in a suitable 3-D display depth direction by the lenticular lens can be determined according to the spacial distances D1, D2 of the corresponding points included in the image regions of the persons O1, O2 while the feed images IL, IR are overlapped so that the corresponding points included in the image regions of the central yacht O3 are in agreement with each other. When the spacial distance is determined based on the integrated value of the difference of the pixel values of the pixel values, it is possible to determine the integrated value by only an addition/subtraction operation. Consequently, the load on the arithmetic and logic operation is low, and a processor without a high processability can handle the operation well. Consequently, carrying out this technology does not raise the cost of the apparatus, and the functions can be realized even in lower priced products. In addition, it is possible to quickly present the suitability determination result to the user.

Now, return to FIG. 2, and the further process in the 3-D image printing mode will be explained. As the minimum value of the differential integrated value is detected, the difference between the shift quantity that displays the smallest minimum value and the shift quantity that displays the second smallest minimum value is computed (step S109). Here, it is believed that the magnitude of the minimum value of the differential integrated value corresponds to the area in the image of the subject for image pickup that has the highest overlap degree at the shift quantity that displays the minimum value. The reason is as follows: when the overlap degree of a subject for image pickup with a large area is higher, the number of corresponding pixels with a difference in the pixel values near zero becomes larger, so that the differential integrated value decreases correspondingly. Here, the minimum value IV3 when the overlap degree of the right-side person O1 having the largest area in the image becomes the maximum is the smallest, and the minimum value IV1 when the overlap degree of the central yacht O3 with a smaller area becomes the maximum is the largest. Also, when the shift quantity is zero, the overlap degree of the far away hill 04 that has an almost zero difference in positions between the feed image IL for the left eye and the feed image IR for the right eye becomes the maximum. Because the area of the hill 04 in the image is large, the differential integrated value displays a small value when the shift quantity is zero.

According to the present embodiment, the minimum value IV3 when the overlap degree of the right-side person O1 having the largest area in the image is the maximum is the smallest. The minimum value IV2 when the left-side person O2 having the next largest area in the image is the maximum becomes the second smallest value. Consequently, by comparing the difference D3 between the shift quantity S2 indicating the minimum value IV2 and the shift quantity S3 indicating the minimum value IV3 with the prescribed threshold that is predetermined corresponding to the lenticular lens, it is possible to determine whether both the persons O1, O2 are suitably displayed in 3-D.

The corresponding threshold is determined according to the magnitude of the parallax corresponding to the range in the depth direction where the image can be suitably displayed in 3-D corresponding to the material of the lenticular lens and the dimensions of the convex lenses, etc. The wider the range in which the 3-D display can be displayed, that is, the larger the parallax degree that can display in 3-D, the higher the threshold. On the other hand, the smaller the range in which the 3-D display can be carried out, the lower the threshold. In this case, even when the D3 (=S3-S2) is lower than the threshold and it is determined that both the persons O1, O2 can be suitably displayed, if D1 (=S3-S1) is over the threshold, the central yacht O3 may still not be suitably displayed in 3-D. However, even in such a case, as the proportion of the area occupied by the central yacht O3 in the image is relatively smaller, it is also believed that a certain non-vividness of the central yacht O3 may be tolerable. In this way, when the suitable 3-D display of the subject having a large proportion of the area in the image is taken as the priority, as in step S109, the difference D3 between the shift quantity S3 indicating the smallest value of the minimum value IV3 and the shift quantity S2 indicating the second smallest minimum value IV2 is determined, and the difference is then compared with the threshold to determine the suitability (step S110).

On the other hand, one should also consider the demand of suitable 3-D display of all of the subjects O1, O2, O3 included in the feed images IL, IR. In order to meet such a demand, among the spacial distances D1, D2, D3 determined as the differences between the various shift quantities S1, S2, S3 indicating the various minimum values IV1, IV2, IV3, the spacial distance D1 having the maximum value is compared with the threshold. In this case, if D1 (=S3-S1) is lower than the threshold, both the right-side person O1 and the central yacht O3 can be suitably displayed in 3-D, at the same time, the left-side person O2 present between the right-side person O1 and the central yacht O3 in the depth direction can also be suitably displayed. In addition, although smoothing has been carried out in step S107, small crests/troughs are still left, and it may be inappropriate to determine the suitability using the method based on such small troughs, that is, the minimum values. In order to avoid this problem, when a determination is made on whether the method is suitable, among the plural minimum values, only the minimum values smaller than the prescribed value are taken as the objects for consideration in computing their spacial distances.

Here, together with the configuration that executes the two suitability determination modes, it is also possible to adopt a configuration in which the user switches the suitability determination mode. One may also adopt a scheme in which plural thresholds are arranged in each suitability determination mode, and the suitability determination result is displayed as 3 or more steps.

When the result of comparison with the threshold indicates that the combination of the feed images IL, IR is suitable for use as the image for 3-D viewing, this result is notified to the user (step S111). On the other hand, when it is determined that the combination of the feed images IL, IR is not suitable, this result is also notified to the user (step S112). As the notification means, for example, the display unit 108 may be used, with the message being displayed on the display unit 108. Also, notification may be carried out by the voice from a speaker or by the flashing or turning on of a lamp, or any other appropriate means. When a command about the printing process is received from the user who has been notified with the result of determination on the suitability by the notification means, the printing process is executed or stopped, depending on the command (step S113).

As explained above, according to the present embodiment, the printing apparatus 100 works as the “image processing apparatus” of the present invention, and the printer engine 113 works as the “printing means” of the present invention. Also, as the CPU 101 executes the prescribed control programs, the function of the “suitability determination means” of the present invention is realized.

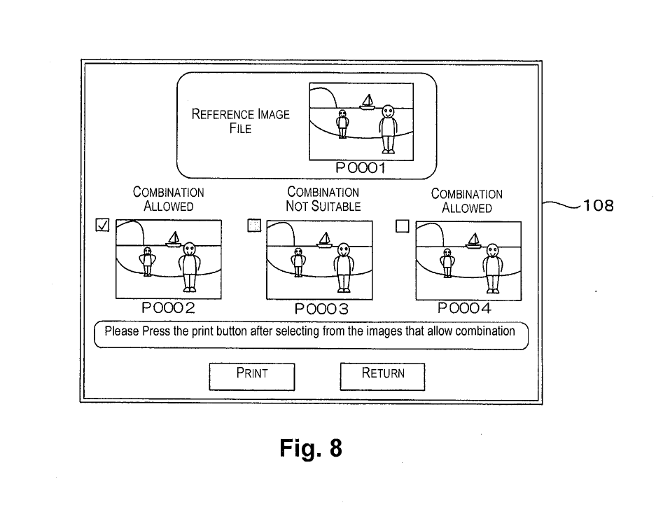

The present invention is not limited to this embodiment. As long as its gist is observed, various modifications can be made. For example, in this embodiment, the left/right feed images IL, IR taken from left/right two views are adopted to form the lenticular image. However, there is no specific restriction on the number of feed images as long as it is 2 or more. This technology may also be adopted in forming a synthetic image from the feed images from plural views, respectively. More specifically, after the user selects the plural feed images, one image among them is assigned as the reference image, and the suitability determination is carried out sequentially for the combinations with the other feed images, respectively. In this way, for example, the determination result may be notified to the user by the display unit 108 shown in FIG. 8.

FIG. 8 is a diagram illustrating an example of the display on the display unit. Here, as an example, the user assigns a reference image file P0001 as the reference image, and selects the comparative image files P0002 through P0004 as the images for checking the combination with this reference image file. As a result of the suitability determination, if it is determined that the combination with the reference image file P0001 is suitable for the image files P0002 and P0004, while the combination with the image file P0001 is not suitable, the result is displayed on the display unit 108.

On the display unit 108, the image files P0001 through P0004 are displayed as the corresponding contracted images arranged side by side. Besides the comparative image files P0002 through P0004, check boxes are displayed. From the image files (the files displayed as “combinable” in FIG. 8) that are determined to be suitable for combination with the reference image file P0001, the user selects a choice by checking the check box for the image file to be used in forming the image for 3-D viewing. The user then presses the printing button to carry out printing of the image for 3-D viewing.

Here, for the comparative image file P0003 determined to be not suitable for combination with the reference image file P0001, the check box is invalidated (cleared out). However, the check box may also be validated. One may also adopt a scheme in which the contracted image of the comparative image file P0003 determined to be not suitable is not displayed as is. Also, for the input to the check box and the button manipulation, for example, the touch panel function of the display unit 108 may be used. According to this notification state, it is easy for the user to find out the suitable combination for the feed image as the image for 3-D viewing from among a few images. By simply selecting one or several images determined to be suitable for combination with the reference image, the user can easily select the feed image suitable for forming the image for 3-D viewing. Also, for the method for selecting the image file and the method of command of the printing process, it is also possible adopt other suitable schemes.

This embodiment, on the prepared feed images IL, IR, it is assumed that there is no offset in the longitudinal positions. However, one may also adopt a scheme in which a determination is made on the suitability for the combination of the feed images IL, IR accompanied by offset in the longitudinal positions as the image for 3-D viewing. In this case, the feed images IL, IR are shifted with respect to each other not only in the left/right direction, but also in the longitudinal direction; the minimum value of the integrated value is detected in the two-dimensional coordinate system and, for example, a suitability determination is carried out based on the shift quantity in the left/right direction (parallax direction) when the minimum value is displayed.

In this embodiment, the procedure is as follows: the differential integrated value is determined for all of the shift quantities, then the minimum point of the differential integrated value is detected. However, one may also adopt a scheme in which detection of the minimum point is sequentially carried out in each step when the feed images IL, IR are shifted with respect to each other.

In this embodiment, the image processing method of the present invention is executed on a printing apparatus 100 that includes a printing system together with the digital camera 200. However, the subjects of application of the present invention are not limited to this. For example, the same image processing method may also be adopted on a stand-alone digital camera or printer, a portable terminal device, a personal computer, etc.

The present invention can be adopted in forming the 3-D viewable image via a lenticular lens.

What is claimed is:

1. An image processing apparatus that forms a 3-D viewable image via a lenticular lens, comprising:
a suitability determination unit that determines the suitability of the combination of the first feed image and the second feed image for the image for 3-D viewing based on a position relationship between corresponding points of a first feed image and a second feed image having a parallax with respect to each other,
and a unit that notifies a user about the determination result obtained by the suitability determination unit;
with the suitability determination unit working as follows: when the first feed image and the second feed image overlap each other so that a pair of corresponding points are in agreement with each other, if the spacial distance between another pair of corresponding points is larger than a threshold preset corresponding to the lenticular lens, it is determined that the combination of the first feed image and the second feed image is not suitable.

2. The image processing apparatus according to claim 1, wherein the suitability determination unit determines, for each shift quantity, an integrated value obtained by integrating an absolute value of the difference in the pixel values of the corresponding pixels in the overlapped regions of the first feed image and the second feed image as the first feed image and the second feed image are shifted.

3. The image processing apparatus according to claim 2, wherein the suitability determination unit determines the suitability based on the spacial distance determined as the difference between the shift quantity indicating the smallest minimum value of the integrated value and the shift quantity indicating the second smallest minimum value.

4. The image processing apparatus according to claim 2, wherein the suitability determination unit determines the suitability based on the maximum spacial distance among the plural spacial distances determined from the shift quantities indicating the minimum values.

5. The image processing apparatus according to claim 1, wherein the notification unit visually displays the second feed image, which has been determined by the suitability determination unit for the suitability of the combination with the first feed image, together with the determination result.

6. The image processing apparatus according to claim 1, further comprising a printing unit for printing and output of the image for 3-D viewing.

7. An image processing method for forming the image for 3-D viewing that can be viewed as 3-D via a lenticular lens, comprising:
determining the suitability of the combination of the first feed image and the second feed image for the image for 3-D viewing based on the position relationship between the corresponding points of the first feed image and the second feed image having a parallax with respect to each other,
notifying the user about the determination result obtained by a suitability determination unit; and
in the determining the suitability, when the first feed image and the second feed image overlap each other, a pair of corresponding points are in agreement with each other, if the spacial distance between another pair of corresponding points is larger than a threshold preset corresponding to the lenticular lens, with it being determined that the combination of the first feed image and the second feed image is not suitable.
